(19) United States
(12) Patent Application Publication
(10) Pub. No.: US 2025/0270672 A1
(43) Pub. Date: Aug. 28, 2025

(54) METHOD FOR RECOVERING PRECURSOR METAL FOR SECONDARY CELL CATHODE MATERIAL USING SYNERGISTIC SOLVENT EXTRACTION APPLIED WITH EXTRACTANT DEGRADATION PREVENTING TECHNOLOGY

(71) Applicant: CIS CHEMICAL CO., LTD., Gwangju (KR)

(72) Inventors: Sung Oh LEE, Gwangju (KR); Chi Jung OH, Gwangju (KR); Jeon Woong AN, Wonju-si (KR); Youn Kyu YI, Gwangju (KR)

(21) Appl. No.: 18/285,840

(22) PCT Filed: Jun. 1, 2023
(86) PCT No.: PCT/KR2023/007496

§ 371 Date: Oct. 5, 2023

(30) Foreign Application Priority Data
Nov. 14, 2022 (KR) 10-2022-0151705

(51) Int. Cl. C22B 7/00; C01G 3/00; C01G 3/10; C22B 3/00; C22B 3/40; C22B 3/44; C22B 15/00; C22B 47/00; H01M 4/505; H01M 4/525

(52) U.S. Cl. CPC C22B 7/007; C01G 3/003; C01G 3/10; C22B 3/404; C22B 3/44; C22B 15/0071; C22B 15/0089; C22B 19/22; C22B 23/043; C22B 23/0461; C22B 47/00; H01M 4/505; H01M 4/525

(57) ABSTRACT

Provided is a method for recovering a precursor metal for secondary cell cathode material using synergistic solvent extraction applied with extractant degradation preventing technology including: (a) leaching a low grade MHP and sulfuric acid by high temperature and high pressure oxidation reaction; (b) separating a solution leached by the oxidation reaction and precipitant of an impurity containing iron (Fe); (c) recovering copper as copper sulfate solution by solvent extraction from the leached solution of (b); (d) precipitating and removing some impurities by injecting a neutralizing agent into a raffinate after solvent extraction of cooper in (c); and (e) recovering zinc, cobalt, and nickel from a solution from which some impurities are removed in (d) by means of the synergetic solvent extraction (SSX) to be selectively separated as a raffinate containing manganese, calcium, and magnesium.

### TECHNICAL FIELD

The present disclosure relates to a method for recovering valuable metals from a low grade MHP (iron removal process residue, and residue containing a large amount of impurities such as iron (Fe) and aluminum (Al)) generated during the process of manufacturing the precursor for secondary cell cathode materials, and more particularly, to an economical method for recovering valuable metals which efficiently separates manganese (Mn), calcium (Ca), magnesium (Mg), and sodium (Na) which are difficult to be separated from existing solvent extraction using synergistic solvent extraction (SSX) to recycle the valuable metals in the low grade MHP and increases a productivity by shortening the time for stripping of nickel after solvent extraction.

Further, the present disclosure relates to a method which is applicable to produce a precursor raw material for secondary cell cathode material with waste battery black powder, mine mixed hydroxide precipitate (MHP), mixed carbonate precipitate (MCP), or mixed sulfide precipitate (MSP), the low grade MHP which is generated during the process of manufacturing the precursor.

### BACKGROUND ART

Due to explosive growth of the electric vehicle market, the world including Korea is making every effort to secure metals, such as nickel (Ni), cobalt (Co), manganese (Mn), and lithium (Li), which are essential to configure a precursor for secondary cell cathode materials. The raw materials which are used by manufacturers to manufacture the precursor for secondary cell cathode materials may be generally divided into black powder generated from the waste batteries and mineral products including nickel (Ni), cobalt (Co), and manganese (Mn).

Currently, the manufacturers of precursors for secondary cell cathode materials are manufacturing precursors for secondary cell cathode materials by means of a process using substandard cathode materials generated during the battery manufacturing process and the MHP produced from the mines in a situation where black powder generated from the waste batteries is not sufficient.

The process of manufacturing the precursor for secondary cell cathode material requires several times of impurity purification and solvent extraction processes to meet a specification of the precursor for secondary cell cathode material required in the market. Despite going through the impurity purification process as the above, it is difficult to effectively separate manganese (Mn), sodium (Na), calcium (Ca), iron (Fe), aluminum (Al), silicon (Si), and sodium (Na), and due to this difficulty, a low grade MHP containing a large amount of valuable metals (nickel (Ni), cobalt (Co), copper (Cu), zinc (Zn), and manganese (Mn)) is generated.

The industry which manufactures the precursor for secondary cell cathode materials already owns and operates facilities which processes black powder and MHP to manufacture the precursor for secondary cell cathode material and discards the low grade MHP generated during the process of manufacturing the precursor for secondary cell cathode materials through waste disposal companies. The low grade MHP which is discarded in this way is being exported to China and so forth, after simply evaporating moisture therefrom through the waste disposal companies.

A technology to be proposed by the present disclosure is to produce a raw material for manufacturing a precursor for secondary cell cathode material (to be injected into the process of manufacturing a precursor for secondary cell cathode material of the related art) by oxygen pressured leaching, purification, and solvent extraction with the low grade MHP which is generated during the process of manufacturing a precursor for secondary cell cathode material as a raw material. At this time, the raw material for manufacturing the precursor for secondary cell cathode material produced from the low grade MHP is recycled in the industry which manufactures the precursor for secondary cell cathode material so that at a small scale, it may be contributed to improving a profitability of the company and at a large scale, to securing national valuable metals and improving a supply chain.

### DISCLOSURE

### Technical Problem

An object of the present disclosure is to provide a method for recovering a precursor metal for secondary cell cathode material using synergistic solvent extraction applied with an extractant degradation preventing technology, and the method provides an economical method for recovering valuable metals which efficiently separates manganese (Mn), calcium (Ca), and magnesium (Mg) which are difficult to be separated through existing solvent extraction and increases a productivity by shortening the time for stripping of nickel after solvent extraction.

The objects of the present disclosure are not limited to the aforementioned object, and other objects, which are not mentioned above, will be apparently understood by the person skilled in the art from the following description.

### Technical Solution

In order to solve the above-described problem, the present disclosure provides a method for recovering a precursor metal for secondary cell cathode material using synergistic solvent extraction applied with extractant degradation preventing technology including (a) a step of leaching a low grade MHP with sulfuric acid by high temperature and high pressure oxidation reaction; (b) a step of separating a solution leached by the oxidation reaction and precipitant of an impurity containing iron (Fe); (c) a step of recovering copper as a copper sulfate solution by solvent extraction from the leached solution of the (b); (d) a step of precipitating and removing some impurities by injecting a neutralizing agent into a raffinate after solvent extraction a copper in the (c); and (e) a step of recovering zinc, cobalt, and nickel from a solution from which some impurities are removed in the (d) by means of the synergetic solvent extraction (SSX) to be selectively separated as a raffinate containing manganese, calcium, and magnesium.

Further, in the present disclosure, in the step (a), an autoclave is used.

Further, in the present disclosure, in the solvent extraction in the step (c), a mixture of kerosene which is a diluent and 2-Hydroxy-5-Nonylacetophenone Oxime and 4-Nonylphenol extractants is used.

Further, in the present disclosure, the neutralizing agent in the step (d) is any one of caustic soda or soda ash and is added to make a pH of the solution 3 to 7.

Further, in the present disclosure, in the synergetic solvent extraction (SSX) of the step (e), a mixture of kerosene which is a diluent and hydroxyalkyloxime, versatic acid, and tributyl phosphate extractants is used.

### Advantageous Effects

The method for producing a raw material for producing a precursor material for a secondary cell cathode material using synergistic solvent extraction (SSX) from a low grade MHP generated during a process of manufacturing a precursor for a secondary cell cathode material according to the exemplary embodiment of the present disclosure is a technology which contributes to securing valuable metals and diversifying the supply chain by suppressing the export of the valuable metals by means of the excellent effects that efficiently separate manganese (Mn), calcium (Ca), and magnesium (Mg) which are difficult to be separated by the existing solvent extraction and increases a productivity by shortening the time for stripping of nickel after solvent extraction to economically recover the valuable metals.

### DESCRIPTION OF DRAWINGS

FIG. 1 is a flowchart for a method for recovering a precursor metal for a secondary cell cathode material using synergistic solvent extraction applied with an extractant degradation preventing technology.

FIG. 2 is a view illustrating a stripping efficiency of nickel (Ni) ion in accordance with a concentration of an extractant when the extractant is mixed, according to an exemplary embodiment of the present disclosure.

### BEST MODE

Hereinafter, exemplary embodiments of the present disclosure will be described in more detail. First, in describing the present disclosure, a detailed description of publicly known functions or configurations incorporated herein will be omitted so as not to make the subject matter of the present disclosure unclear.

The terms “about or approximately” or “substantially” indicating a degree used throughout the specification are used as a numerical value or a meaning close to the numerical value when a unique manufacturing and material tolerance is proposed to the mentioned meaning and also used to prevent unscrupulous infringers from wrongfully using the disclosure in which precise or absolute numerical values are mentioned for better understanding of the present disclosure.

As terms used in the present disclosure, general terms which are currently widely used are selected as much as possible. However, in certain cases, terms which are arbitrarily selected by the applicant may be used and, in this case, the meaning thereof needs to be understood by considering the meaning which is described or used in a specific content for carrying out the disclosure, rather than simply considering the name of the term.

Hereinafter, a technical configuration of the present disclosure will be described in detail with reference to exemplary embodiments illustrated in the accompanying drawings.

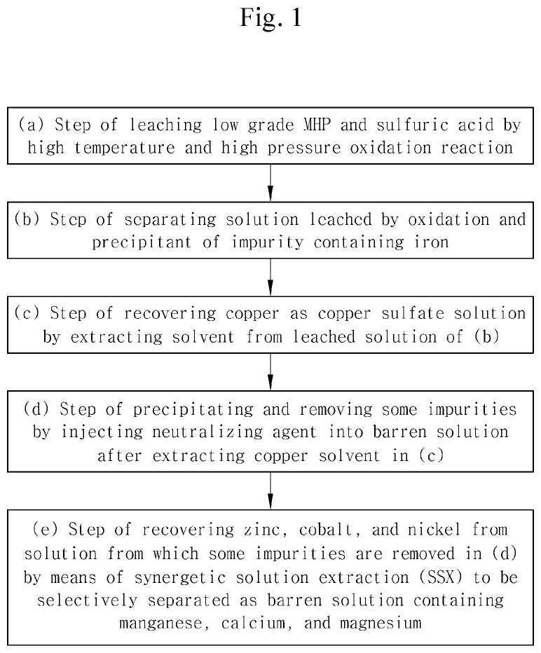

FIG. 1 is a flowchart for a method for recovering a precursor metal for a secondary cell cathode material using synergistic solvent extraction applied with an extractant degradation preventing technology. A step (a) of leaching a low grade MHP with sulfuric acid through high temperature and high-pressure oxidation reaction of the present disclosure will be described.

At this time, in the step (a), the low grade MHP and water are mixed and sulfuric acid is added. At this time, the sulfuric acid may be added by considering an equivalent ratio of ions to be leached and a pH after the leaching.

In the meantime, the low grade MHP, water, and sulfuric acid may be added to a reactor and then charged into an autoclave. After charging into the autoclave, the reaction may be performed for 1 to 5 hours, and more desirably, for 1 to 3 hours.

A reaction temperature of the autoclave is adjusted to 100 to 200° C. and more desirably, to 120 to 170° C. and an oxygen injection pressure may be adjusted to 2 to 20 kg/cm², and more desirably, to 5 to 15 kg/cm².

At this time, the oxygen injection pressure may be adjusted depending on a precipitation type of iron (Fe) ions or a leaching rate.

The valuable metal is leached by the reaction after charging into the autoclave and reaction formulae therefor are as follows.

MeO(Fe, Cu, Co, Ni, Zn, Mn)+H₂SO₄=Me²⁺+SO₄²⁻ [Reaction Formula 1]

2FeSO₄+0.5O₂+2H₂O=Fe₂O₃+2H₂SO₄ [Reaction Formula 2]

After the step (a), a step (b) of separating a solution leached by the oxidation reaction and a precipitate of impurities containing iron (Fe) is continued.

The step (b) is a step of separating some iron (Fe) and impurities by means of solid-liquid separation of the leached solution and recovering a solution in which metals containing copper (Cu), zinc (Zn), manganese (Mn), cobalt (Co), nickel (Ni), iron (Fe), silicon (Si), aluminum (Al), and calcium (Ca) are leached.

In the step (b), iron ions are precipitated as Fe₂O₃ according to the oxygen injection pressure and the temperature adjusted during the reaction to be recovered as residues along with some impurities which have not been eluted.

In the step (b), a solid slurry is separated, and the liquid may be recovered by the solid-liquid separation on the solution recovered by the reaction formula.

The metals in the step (b) are configured by valuable metals to be recovered and impurity metals and the value metals include copper (Cu), zinc (Zn), manganese (Mn), cobalt (Co), and nickel (Ni) and the impurities include iron (Fe), silicon (Si), aluminum (Al), and calcium (Ca).

However, it is not necessarily limited to the above-described examples but may be various metals (including valuable metals) generated from the low grade MHP.

Further, a content of the valuable metals included in the low grade MHP may vary depending on a source of the low grade MHP, so that it is not specifically limited.

That is, the solution recovered by the solid-liquid separation of the step (b) is a solution in which valuable metals to be recovered, such as copper (Cu), cobalt (Co), nickel (Ni), zinc (Zn), and manganese (Mn), are leached. At this time, there are impurities such as iron (Fe), silicon, aluminum, and calcium (Ca) in the solution recovered in the step (b) as well as the valuable metals so that it is difficult to selectively recover the valuable metals.

Thereafter, a step (c) of recovering copper as a copper sulfate solution by solvent extraction from the solution in the step (b) is continued.

The step (c) is a step of recovering copper from the leached solution using solvent extraction and the solvent extraction of the step (c) uses a mixture of kerosene which is a diluent and 2-hydroxy-5-nonylacetophenone oxime and 4-nonylphenol extractants.

A concentration of the extractant used in the step (c) may be adjusted depending on a copper content of the leached solution and a concentration of the extractant in the solvent may be 5 to 30 v/v % based on a total volume of the solvent.

In the solvent extraction of the step (c), sulfuric acid and a neutralizing agent are used to adjust the pH to 1 to 3, and more desirably, to 1.5 to 2.5 and specific reaction formulae of the step (c) are as follows.

CuSO₄(aq)+R—H₂(Org)→R—Cu(org)+H₂SO₄ [Reaction Formula 3: Extraction]

R—Cu(org)+H₂SO₄→R—H₂(Org)+CuSO₄ [Reaction Formula 4: Stripping]

Consequently, only copper is separated by the step (c) to be recovered as a copper sulfate solution and a raffinate contains cobalt (Co), nickel (Ni), zinc (Zn), manganese (Mn), iron (Fe), aluminum (Al), and calcium (Ca).

In the meantime, the copper sulfate solution recovered in the step (c) is reprocessed if necessary to prepare a thin copper material (copper sulfate).

Next, after extracting a copper solvent in the step (c), a step (d) of precipitating and removing some impurities by injecting a neutralizing agent into the raffinate is continued.

At this time, the neutralizing agent in the step (d) is any one selected from caustic soda and soda ash and the neutralizing agent is added to make pH of the solution 3 to 7, and more desirably, 4 to 6.

The impurities which are removed by the step (d) are iron (Fe), silicon (Si), and aluminum (Al) and to be more specific, the reaction is performed for 10 to 240 minutes, and more desirably for 100 to 120 minutes after adding the neutralizing agent.

Iron (Fe) is removed in the form of 2Fe(OH)₃ or Fe₂ (SO₄)₃ and aluminum is removed in the form of 2Al(OH); by the pH which is adjusted as described above and specific reaction formula therefor are as follows.

Al₂(SO₄)₃(a)+3H₂O=2Al(OH)₃(s)+3H₂SO₄ [Reaction Formula 5]

Fe₂(SO₄)₃(a)+3H₂O=2Fe(OH)₃₍ₛ₎+3H₂SO₄ [Reaction Formula 6]

2FeSO₄(a)+1/2O₂+H₂SO₄=Fe₂(SO₄)₃₍ₛ₎+H₂O [Reaction Formula 7]

In the step (d), the solid-liquid separation is performed on the solution which is recovered by the above-described reaction formula to separate a solid slurry and recover the liquid. The solution which is recovered by the above-described step (d) and the solid-liquid separation is a solution in which the impurities, such as iron (Fe) and aluminum, are removed and valuable metals to be recovered are included. However, the impurity, such as calcium (Ca), is still present so that it is difficult to produce a raw material for the process of manufacturing a precursor for a secondary cell cathode material without adjusting a ratio of nickel and other metals.

Next, a step (e) of selectively separating manganese (Mn), calcium (Ca), and magnesium (Mg) as a raffinate by recovering zinc (Zn), cobalt (Co), and nickel (Ni) from a solution from which some impurities are removed in the step (d) by means of the synergetic solvent extraction (SSX) is included.

At this time, in the synergetic solvent extraction (SSX) of the step (e), a mixture of kerosene which is a diluent and hydroxyalkyloxime, versatic acid, and tributyl phosphate extractants is used.

At this time, a concentration of the extractant may be adjusted depending on a concentration of the valuable metals to be recovered and the solution recovered for the selective separation of the valuable metal may be diluted using a industial water.

At this time, a concentration of the hydroxyalkyloxime extractant of the solvent may be 0.1 to 2 mol/L.

At this time, a concentration of the versatic acid extractant of the solvent may be 0.1 to 2 mol/L.

At this time, a concentration of the tributyl phosphate extractant of the solvent may be 0.1 to 2 mol/L.

In the synergetic solvent extraction (SSX) in the step (e), in order to suppress the degradation of the solvent when the mixed extractant is stored, the solvent and the aqueous solution (distilled water or weak acid) need to be stirred to be stored.

In the meantime, in the synergetic solvent extraction (SSX) in the step (e), a ratio of extractants mixed to suppress the degradation of the solvent needs to be confirmed through analysis during continuous operations and the extractant needs to be added so that the ratio of the extractant is not changed.

At this time, when the extractant is added, an order of adding the extractant also needs to be considered.

An extraction reaction to selectively separate manganese (Mn), calcium (Ca), and magnesium (Mg) by utilizing a solvent in which a concentration of the extractant is adjusted is generated in accordance with the following reaction formulae.

ZnSO₄(aq)+R—H₂(Org)→R—Zn(org)+H₂SO₄ [Reaction Formula 8:Extraction]

CoSO₄(aq)+R—H₂(Org)→R—Co(org)+H₂SO₄ [Reaction Formula 9: Extraction]

NiSO₄(aq)+R—H₂(Org)→R—Ni(org)+H₂SO₄ [Reaction Formula 10: Extraction]

MnSO₄(aq)+R—H₂(Org)→R—Mn(org)+H₂SO₄ [Reaction Formula 11: Extraction]

In the meantime, in order to improve the efficiency of the solvent extraction, pH is adjusted to 4 to 7, and more desirably, to 4 to 6 using sulfuric acid and alkaline reagents and by doing this, zinc (Zn), cobalt (Co), and nickel (Ni) are extracted, and manganese (Mn), magnesium (Mg), and calcium (Ca) may be selectively separated as the raffinate.

In the meantime, when the extraction is performed in a high pH area to improve the efficiency of the solvent extraction, a manganese (Mn) extraction efficiency is increased, which is a main cause of the degradation of the hydroxyalkyloxime. In the synergetic solvent extraction (SSX), high manganese (Mn) extraction causes the degradation of the extractant so that pH should be adjusted during the extraction.

For the above reason, if the extractant degradation (oxime degradation) progresses, the oxime of the extractant (hydroxyalkyloxime) prepared based on an amount of metal to be extracted in the synergetic solvent extraction is lowered. Therefore, a mole total metal/mole oxime in the extracted solvent is increased, which causes the degradation of the extractant, so that the increase of the amount of extracted manganese (Mn) needs to be prevented.

In the meantime, even though most of manganese (Mn) may be selectively separated by adjusting the pH, a small amount of manganese (Mn) is extracted into the solvent and the extracted manganese (Mn) causes the degradation of the extractant so that it should be removed. Therefore, a scrubbing step is performed.

At this time, as a scrubbing solution of the scrubbing step, a solution in which a sulfuric acid is adjusted to 2 to 20 g/L may be used to separate the manganese (Mn) and in order to increase a removal rate of manganese (Mn), zinc sulfate, cobalt sulfate, and nickel sulfate may be dissolved in the sulfuric acid solution to be used.

The scrubbing step is generated according to the following reaction formula and manganese (Mn) which is an impurity may be removed.

R—Mn(org)+MeSO₄→R—Co(Org)+MeSO₄ [Reaction Formula 12: Scrubbing]

In the meantime, a solvent from which manganese (Mn) is removed by the scrubbing step may recover zinc, cobalt, and nickel by stripping according to the following reaction formulae.

R—Zn(org)+H₂SO₄→R—H₂(Org)+ZnSO₄ [Reaction Formula 13: Stripping]

R—Co(org)+H₂SO₄→R—H₂(Org)+CoSO₄ [Reaction Formula 14: Stripping]

R—Ni(org)+H₂SO₄→R—H₂(Org)+NiSO₄ [Reaction Formula 15: Stripping]

At this time, a sulfuric acid concentration of a stripping may be adjusted to 10 to 100 g/L, and more desirably, 20 to 70 g/L to be used.

At this time, in order to increase the stripping efficiency, a concentration of tributyl phosphate (TBP) extractant may be adjusted to 0.5 to 2 mol/L.

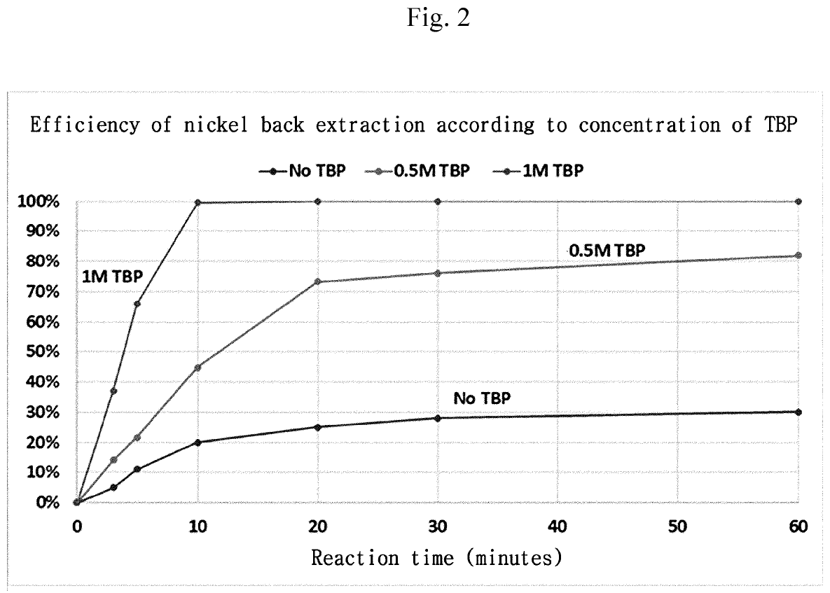

At this time, the stripping efficiency varies depending on the concentration of the tributyl phosphate extractant and the stripping efficiency is illustrated in FIG. 2.

Consequently, in the step (e), manganese (Mn), calcium (Ca), and magnesium (Mg) are selectively removed as the raffinate and a sulfuric acid solution containing zinc (Zn), cobalt (Co), and nickel (Ni) which are valuable metals may be recovered.

In the meantime, zinc sulfate, cobalt sulfate, and nickel sulfate solutions which are recovered in the step (e) are reprocessed if necessary to be produced as a secondary cell raw material.

In the meantime, manganese (Mn), calcium (Ca), and magnesium (Mg) solutions in the raffinate of the step (e) are precipitated and reprocessed if necessary to be produced as a secondary cell raw material.

Hereinafter, a specific experimental example according to an exemplary embodiment of the present disclosure will be described in detail.

### [Experimental Example 1] Oxygen Pressure Leaching Step of Low Grade MHP

In the oxygen pressure leaching step of a low grade MHP, 25 g of a low grade MHP sample and 200 g of DI water were mixed under the condition of 10% of pulp density. Before being charged into the autoclave, sulfuric acid and hydrogen peroxide calculated by considering an equivalent ratio of the ions to be leached and the pH after leaching were added to the reactor and then charged into the autoclave.

As the condition to improve a leaching rate and induce the precipitation of iron (Fe) oxide during the oxygen pressure leaching, the temperature was adjusted to 140 to 170° C. and an oxygen injection pressure was adjusted to 3 to 10 kg/cm² to perform the reaction for one hour.

The analysis result of components of the low grade MHP and the residues of the oxygen pressure leaching after the reaction were shown in the following Tables and as a result, 99% or more of copper (Cu), cobalt (Co), nickel (Ni), and zinc (Zn) which were valuable metals to be recovered were eluted.

TABLE 1

| Element | Low grade MHP (wt %) |
|---|---|
| Mn | 19.3 |
| Ni | 6.5 |
| Zn | 9.1 |
| Cu | 3.4 |
| Fe | 3.8 |
| Al | 4.7 |
| Co | 1.2 |
| Ca | 0.6 |
| Mg | 0.2 |

TABLE 2

| Element | Oxygen pressure leaching (wt %) |
|---|---|
| Mn | 9.5 |
| Ni | 0.1< |
| Zn | 0.1< |
| Cu | 0.1< |
| Fe | 3.5 |
| Al | 2.9 |
| Co | 0.1< |
| Ca | 0.1< |
| Mg | 0.1< |

Referring to Table 1 of component analysis of a low grade MHP before the step (a) of the method for recovering a precursor metal for a secondary cell cathode material using synergetic solvent extraction applied with an extractant degradation preventing technology and Table 2 of component analysis of a low grade MHP after the step (a), a change in a content of the MHP by a solution leached by the oxidation reaction was shown.

### [Experimental Example 2] Iron (Fe) and Aluminum Removing Step

Since the solution contained valuable metals such as nickel (Ni), cobalt (Co), zinc (Zn), and manganese (Mn) and impurities such as calcium (Ca), iron (Fe), silicon (Si), and aluminum (Al), in order to remove iron (Fe), silicon (Si), and aluminum (Al), approximately 0.5 L of the solution was prepared.

In the solution, a concentration of the valuable metal is higher than the concentration of impurities, so that in order to control co-precipitation of the valuable metals and facilitate solid-liquid separation when iron (Fe), silicon (Si), and aluminum (Al) are removed, the removal step was performed by adjusting a concentration of the metal in the solution.

The pH of the solution was adjusted to 4 to 5 with a 10% (by weight) solution of soda ash which was a neutralizing agent at room temperature.

After precipitating iron (Fe), silicon (Si), and aluminum (Al) by performing the reaction for 30 to 90 minutes while adjusting the pH, the solid slurry was discarded and a solution from which iron (Fe), silicon (Si), and aluminum (Al) were removed was recovered by means of the solid-liquid separation.

The following table represents compositions of a solution in which raffinate and distilled water were mixed to remove iron (Fe), silicon (Si), and aluminum (Al) and a solution recovered after removing the impurity.

TABLE 3

| Element/ppm | Before removing | After removing |
|---|---|---|
| Mn | 6,349 | 4,681 |
| Ni | 2,484 | 1,768 |
| Zn | 3,379 | 3,171 |
| Fe | 307 | 5< |
| Al | 1,042 | 5< |
| Co | 246 | 180 |
| Ca | 213 | 156 |
| Mg | 52 | 5< |

Table 3 is the analysis result of components of filtered solution before removing the impurity (diluent) and after removing the impurity. Specifically, the change in the contents of iron (Fe), aluminum (Al), and magnesium (Mg) was significant.

### [Experimental Example 3] Synergetic Solvent Extraction (SSX) Step after Removing Impurity

The solution from which the impurity is removed contains impurities such as cobalt (Co), nickel (Ni), zinc (Zn), manganese (Mn), calcium (Ca), and magnesium (Mg) so that it is difficult to selectively separate and recover the valuable metals to be recovered.

Accordingly, 0.16 L of the solution was prepared to perform solvent extraction to extract zinc (Zn), cobalt (Co), and nickel (Ni) and selectively separate manganese (Mn), calcium (Ca), and magnesium (Mg) from the recovered solution.

Solvent extraction was prepared by mixing hydroxyalkyloxime, versatic acid, and tributyl phosphate extractants and Kerosene-based diluents.

200 ml of solvent mixed with the diluent was used by adjusting a concentration of the extractant of hydroxyalkyloxime to 0.2 to 0.5 mol/L, a concentration of the extractant of versatic acid to 0.3 to 1 mol/L, and a concentration of tributyl phosphate extractant to 0.5 to 2 mol/L.

(Extraction) The solvent extraction was performed by mixing the solvent and a solution from which the impurities were removed at a volume ratio of 1.25:1 and pH was adjusted to 4 to 7 with a 1 to 10% (by weight) solution of soda ash which was a neutralizing agent during the extraction.

(Scrubbing) In order to scrub manganese (Mn) to be separated during the solvent extraction, the solvent and a scrubbing solution were used with a volume ratio of 1:1. As the scrubbing solution in the scrubbing step, 3 to 10 g/L of nickel and a solution with pH adjusted to 3 to 5 were used.

(Stripping) In order to recover the valuable metals in the aqueous phase, the solvent that has undergone the scrubbing step was stirred for the reaction time of 5 to 20 minutes by adjusting a concentration of sulfuric acid to 30 to 60 g/L to recover zinc (Zn), cobalt (Co), and nickel (Ni).

In the solvent extraction step, an organic phase and an aqueous phase were separated through a separatory funnel after the reaction and an amount extracted into the solvent was reversely calculated by means of the aqueous phase analysis after solvent extraction and the analysis result of component was represented in the following Table.

TABLE 4

| Element/ppm | PLS | Raffinate | Scrubbing | Stripping |
|---|---|---|---|---|
| Mn | 4,433 | 4,150 | 261 | 5< |
| Ni | 1,691 | 569 | 4,165 | 3,000 |
| Zn | 3,072 | 259 | 1,857 | 612 |
| Co | 170 | 5< | 66 | 32 |
| Ca | 148 | 130 | 5< | 5< |
| Mg | 5< | 5< | 5< | 5< |

Table 4 shows the analysis result of the component of the selective separation and solvent extraction of manganese (Mn), calcium (Ca), and magnesium (Mg).

As represented in the analysis result, even though it was understood that in the extraction step, zinc (Zn), cobalt (Co), and nickel (Ni) of the solvent were mostly extracted and manganese (Mn) to be separated was partially extracted, it was confirmed that manganese was removed during the scrubbing step to be separated as a scrubbing solution. Further, it was confirmed that in the stripping, zinc (Zn), cobalt (Co), and nickel (Ni) were recovered into the solution.

In the meantime, after the scrubbing step, the post-scrubbing solution containing manganese (Mn) was recycled as a feed solution in the extraction step.

The foregoing present disclosure is not limited to the foregoing examples and the accompanying drawings. It will be apparent to those skilled in the art that various modifications and changes may be made without departing from the scope and spirit of the disclosure.

1. A method for recovering a precursor metal for secondary cell cathode material using synergistic solvent extraction applied with an extractant degradation preventing technology, comprising:
(a) a step of leaching a low grade MHP with sulfuric acid by high temperature and high-pressure oxidation reaction;
(b) a step of separating a solution leached by the oxidation reaction and precipitant of an impurity containing iron (Fe);
(c) a step of recovering copper as a copper sulfate solution by solvent extraction from the leached solution of the step (b);
(d) a step of precipitating and removing some impurities by injecting a neutralizing agent into a raffinate after solvent extraction of cooper in the step (c); and
(e) a step of recovering zinc (Zn), cobalt (Co), and nickel (Ni) from a solution from which some impurities are removed in the step (d) by means of the synergetic solvent extraction (SSX) to be selectively separated as a raffinate containing manganese (Mn), calcium (Ca), and magnesium (Mg).

2. The method according to claim 1, wherein in the step (a), an autoclave is used.

3. The method according to claim 1, wherein in the solvent extraction in the step (c), a mixture of kerosene which is a diluent and 2-Hydroxy-5-Nonylacetophenone Oxime and 4-Nonylphenol extractants is used.

4. The method according to claim 1, wherein the neutralizing agent in the step (d) is any one of caustic soda or soda ash and is added to make a pH of the solution 3 to 7.

5. The method according to claim 1, wherein in the synergetic solvent extraction (SSX) of the step (e), a mixture of kerosene which is a diluent and hydroxyalkyloxime, versatic acid, and tributyl phosphate extractants is used.
